(19) United States
(12) Patent Application Publication
(10) Pub. No.: US 2016/0343168 A1
(43) Pub. Date: Nov. 24, 2016

(54) VIRTUAL PERSONIFICATION FOR AUGMENTED REALITY SYSTEM

(71) Applicant: DAQRI, LLC, Los Angeles, CA (US)

(72) Inventors: Brian Mullins, Altadena, CA (US); Matthew Kammerait, Studio City, CA (US)

(21) Appl. No.: 15/159,743

(22) Filed: May 19, 2016

Related U.S. Application Data
(60) Provisional application No. 62/164,177, filed on May 20, 2015.

(51) Int. Cl. G06T 19/00; G06T 3/00; G06F 3/01; G02B 27/01; G06T 13/40

(52) U.S. Cl. CPC G06T 19/006; G02B 27/0172; G06T 13/40; G06F 3/011; G06T 3/0006; G02B 2027/0141; G02B 2027/014; G02B 2027/0138

(57) ABSTRACT

A head mounted device (HMD) includes a transparent display, a first set of sensors, a second set of sensors, and a processor. The first set of sensors measures first sensor data including an identification of a user of the HMD and a biometric state of the user of the HMD. The second set of sensors measures second sensor data including a location of the HMD and ambient metrics based on the location of the HMD. The HMD determines a user-based context based on the first sensor data, determines an ambient-based context based on the second sensor data, determines an application context within an AR application implemented by the processor, identifies a virtual fictional character based on a combination of the user-based context, the ambient-based context, and the application context, and displays the virtual fictional character in the transparent display.

### REFERENCE TO RELATED APPLICATION

This application claims the benefit of priority of U.S. Provisional Application No. 62/164,177 filed May 20, 2015, which is herein incorporated by reference in its entirety.

### TECHNICAL FIELD

The subject matter disclosed herein generally relates to the processing of data. Specifically, the present disclosure addresses systems and methods for virtual personification in augmented reality content.

### BACKGROUND

A device can be used to generate and display data in addition to an image captured with the device. For example, augmented reality (AR) is a live, direct or indirect view of a physical, real-world environment whose elements are augmented by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network suitable for an augmented reality system, according to some example embodiments.

FIG. 2 is a block diagram illustrating an example embodiment of modules (e.g., components) of a head mounted device.

FIG. 3 is a block diagram illustrating an example embodiment of sensors in a head mounted device.

FIG. 4 is a block diagram illustrating an example embodiment of modules of a personification module.

FIG. 5 is a block diagram illustrating an example embodiment of modules of a server.

FIG. 6 is a ladder diagram illustrating an example embodiment of virtual personification for an augmented reality system.

FIG. 7 is a ladder diagram illustrating another example embodiment of virtual personification for an augmented reality system.

FIG. 8 is a flowchart illustrating an example operation of virtual personification for an augmented reality system.

FIG. 9 is a flowchart illustrating another example operation of virtual personification for an augmented reality system.

FIG. 10 is a flowchart illustrating another example operation of virtual personification for an augmented reality system.

FIG. 11A is a diagram illustrating a front view of an example of a head mounted display used to implement the virtual personification.

FIG. 11B is a diagram illustrating a side view of an example of a head mounted display used to implement the virtual personification.

FIG. 12 is a block diagram illustrating components of a machine, according to some example embodiments, able to read instructions from a machine-readable medium and perform any one or more of the methodologies discussed herein.

FIG. 13 is a block diagram illustrating a mobile device, according to an example embodiment.

### DETAILED DESCRIPTION

Example methods and systems are directed to data manipulation based on real world object manipulation. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Augmented reality (AR) applications allow a user to experience information, such as in the form of a three-dimensional virtual object overlaid on an image of a physical object captured by a camera of a viewing device. The physical object may include a visual reference that the augmented reality application can identify. A visualization of the additional information, such as the three-dimensional virtual object overlaid or engaged with an image of the physical object, is generated in a display of the device. The three-dimensional virtual object may be selected based on the recognized visual reference or captured image of the physical object. A rendering of the visualization of the three-dimensional virtual object may be based on a position of the display relative to the visual reference. Other augmented reality applications allow a user to experience visualization of the additional information overlaid on top of a view or an image of any object in the real physical world. The virtual object may include a three-dimensional virtual object or a two-dimensional virtual object. For example, the three-dimensional virtual object may include a three-dimensional view of a chair or an animated dinosaur. The two-dimensional virtual object may include a two-dimensional view of a dialog box, menu, or written information such as statistics information for a baseball player. An image of the virtual object may be rendered at the viewing device.

Virtual objects may include symbols such as an image of an arrow, or other abstract objects such as virtual lines perceived on a floor to show a path. The user may pay less attention to abstract objects than virtual characters or avatars. For example, the user of a Head Mounted Display (HMD) may be more receptive to listening and watching a virtual character demonstrating how to operate or fix a machine (e.g., tool used in a factory) than listening to audio instructions. The user may feel more connected to listening to a virtual character rather than viewing abstract visual symbols (e.g., arrows). Furthermore, the virtual character may be based on the task performed by the user. For example, a technician fixing an air conditioning machine may see a virtual character in the form of another electrician (e.g., virtual character having a similar electrician uniform).

Different virtual characters may be displayed based on the task, conditions of the user, and conditions ambient to the HMD. Examples of tasks include fixing a machine, assembling components, checking for leaks, and so forth. The task may be identified by the user of the HMD or may be detected by the HMD based on the user credentials, the time and location of the HMD, and other parameters. The conditions of the user may identify how the user feels physically and mentally while performing the task by looking at user-based sensor data. Examples of user-based sensor data include a heart rate and an attention level. The conditions of the user may also be referred to as user-based context. The conditions ambient to the HMD may identify parameters related to the environment local to the HMD while the user is performing or about to perform a task by looking at context-based sensor data. Examples of context-based sensor data include ambient temperature, ambient humidity level, and ambient pressure. The conditions ambient to the HMD may also be referred to as ambient-based context.

For example, a virtual peer electrician may be displayed in a transparent display of the HMD when the HMD detects that the user (e.g., electrician) is installing an appliance. A virtual city inspector may be displayed in the transparent display of the HMD when the HDM detects that the user (e.g., electrician) is verifying that electrical connections comply with city codes. A virtual supervisor may be displayed in the transparent display of the HMD when the HMD detects that the user is unfocused or nervous and needs a reminder. A virtual firefighter may be displayed in the transparent display of the HMD when the HMD detects that toxic fumes from another room are approaching the location of the user.

In other examples, a virtual character may be an avatar for a remote user. For example, the virtual character may be an avatar of a surgeon located remotely from the user of the HMD. The virtual character is animated based on the audio input from the remote surgeon. For example, the mouth of the virtual character moves based on the audio input of the remote surgeon.

A system and method for virtual personification for augmented reality (AR) system are described. A head mounted device (HMD) includes a transparent display, a first set of sensors to generate user-based sensor data related to a user of the HMD, and a second set of sensors to generate ambient-based sensor data related to the HMD. The HMD determines a user-based context based on the user-based sensor data, an ambient-based context based on the ambient-based sensor data, and an application context of an AR application. The application context identifies a task performed by the user. An example of an application context may be a repair task of a factory tool using the AR application to guide the user in steps for diagnosing and repairing the factory tool. The HMD identifies a virtual character based on a combination of at least one of the user-based context, the ambient-based context, and the application context. The virtual character is displayed in the transparent display.

The HMD may identify an object in an image generated by a camera of the HMD. The object may be in a line of sight of the user through the transparent display. The HMD may access the virtual character based on an identification of the object and adjust a size and a position of the virtual character in the transparent display based on a relative position between the object and the camera. For example, the size of the virtual character may be in proportion to the distance between the object and the camera. Therefore, the virtual character may appear smaller when the object is further away from the camera of the HMD and larger when the object is closer to the camera of the HMD. The object may be any physical object such as a chair or a machine. The virtual character may be displayed in the transparent display to be perceived as standing next to the machine or sitting on the chair.

In one example embodiment, the first set of sensors is configured to measure at least one of a heart rate, a blood pressure, brain activity, and biometric data related to the user. The second set of sensors is configured to measure at least one of a geographic location of the HMD, an orientation and position of the HMD, an ambient pressure, an ambient humidity level, and an ambient light level.

In another example embodiment, the HMD identifies, selects, or forms a character content for the virtual character. Examples of character content include animation content and speech content. For example, the animation content identifies how the virtual character moves and is animated. The speech content contains speech data for the virtual character. The character content may be based on a combination of at least one of the user-based context, the ambient-based context, and the application context.

In another example embodiment, the HMD detects a change in at least one of the user-based context, the ambient-based context, and the application context, and changes the virtual character or adjusts the character content of the virtual character based on the change. For example, a different virtual character may be displayed based on a change in the user-based context, the ambient-based context, or the application context. In another example, the animation or speech content of the virtual character in being displayed in the HMD may be adjusted based on a change in the user-based context, the ambient-based context, or the application context.

In another example embodiment, the HMD identifies the virtual character based on the application context. The virtual character may include an avatar representing a virtual presence of a remote user. The HMD records an input (e.g., voice data) from the user of the HMD and communicates the input to a remote server. The HMD then receives audio data in response to the input, and animates the virtual character based on the audio data. For example, the lips of the virtual character may move and be synchronized based on the audio data.

In another example embodiment, the HMD identifies the virtual character based on a task performed by the user and generates character content for the virtual character. The character content may be based on a combination of the task, the user-based context, the ambient-based context, and the application context.

In another example embodiment, the HMD compares the user-based sensor data with reference user-based sensor data for a task performed by the user. The HMD then determines the user-based context based on the comparison of the user-based sensor data with the reference user-based sensor data. The HMD also compares the ambient-based sensor data with reference ambient-based sensor data for the task performed by the user. The HMD then determines the ambient-based context based on the comparison of the ambient-based sensor data with the reference ambient-based sensor data.

The reference user-based sensor data may include a set of physiological data ranges for the user corresponding to the first set of sensors. A first set of the physiological data ranges may correspond to a first virtual character. A second set of physiological data ranges may correspond to a second virtual character.

The reference ambient-based sensor data may include a set of ambient data ranges for the HMD corresponding to the second set of sensors. A first set of ambient data ranges may correspond to the first virtual character. A second set of ambient data ranges may correspond to the second virtual character.

In another example embodiment, the HMD may also change the virtual character based on whether the user-based sensor data transgress the set of physiological data ranges for the user, and whether the ambient-based sensor data transgress the set of ambient data ranges for the HMD.

In another example embodiment, a non-transitory machine-readable storage device may store a set of instructions that, when executed by at least one processor, causes the at least one processor to perform the method operations discussed within the present disclosure.

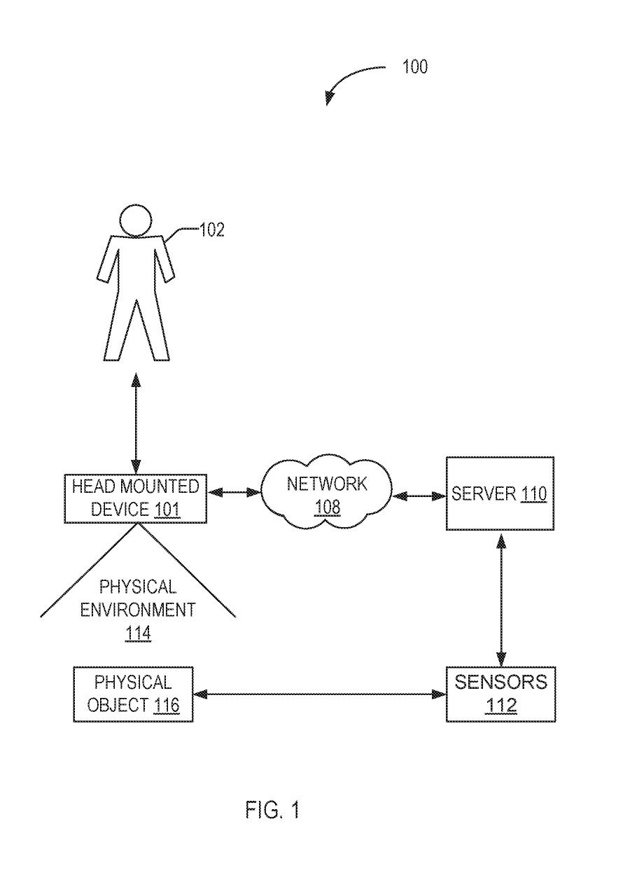

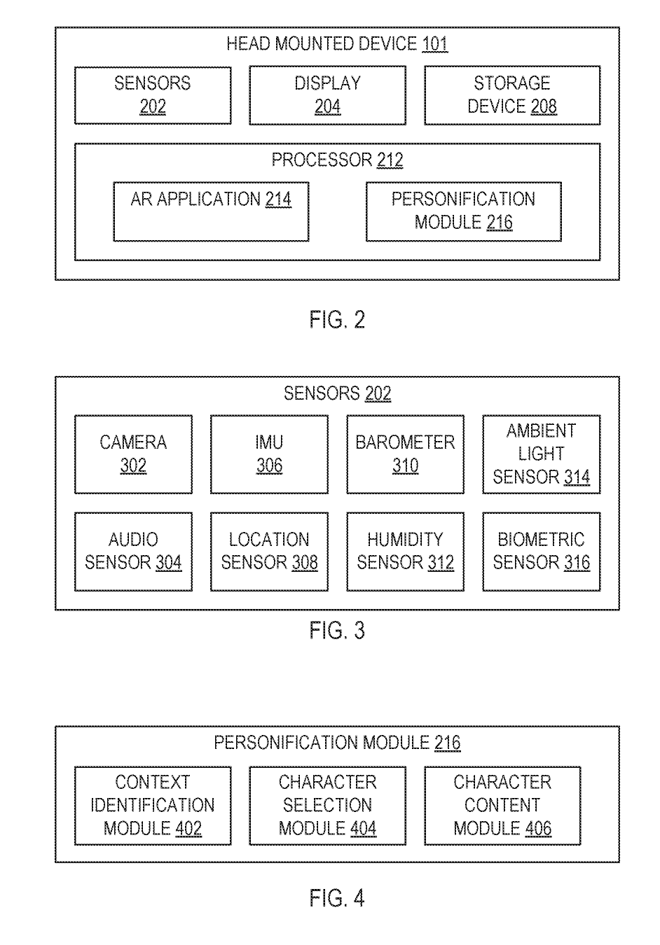

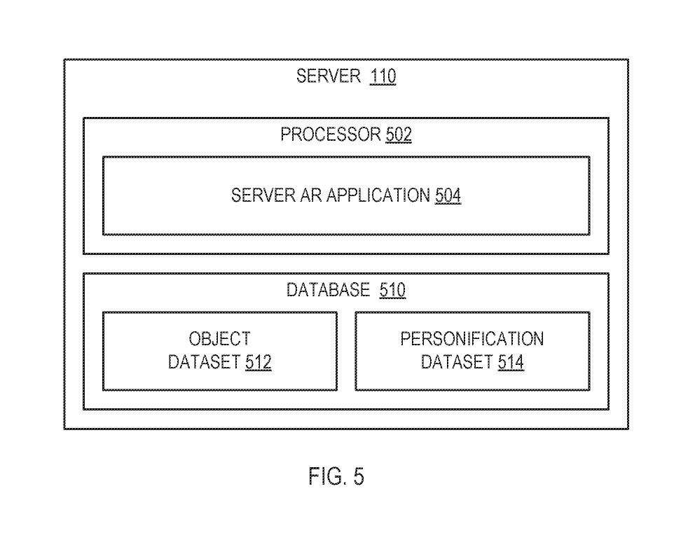

FIG. 1 is a network diagram illustrating a network environment 100 suitable for operating an augmented reality application of a device, according to some example embodiments. The network environment 100 includes a head mounted device (HMD) 101 and a server 110, communicatively coupled to each other via a network 108. The HMD 101 and the server 110 may each be implemented in a computer system, in whole or in part, as described below with respect to FIGS. 2 and 5.

The server 110 may be part of a network-based system. For example, the network-based system may be or include a cloud-based server system that provides AR content (e.g., virtual character 3D model, augmented information including 3D models of virtual objects related to physical objects in images captured by the HMD 101) to the HMD 101.

The HMD 101 may include a helmet that a user 102 may wear to view the AR content related to captured images of several physical objects (e.g., object 116) in a real world physical environment 114. In one example embodiment, the HMD 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the HMD 101. In another example, the display of the HMD 101 may be a transparent display, such as in the visor or face shield of a helmet, or a display lens distinct from the visor or face shield of the helmet.

The user 102 may be a user of an AR application in the HMD 101 and at the server 110. The user 102 may be a human user (e.g., a human being), a machine user (e.g., a computer configured by a software program to interact with the HMD 101), or any suitable combination thereof (e.g., a human assisted by a machine or a machine supervised by a human). The user 102 is not part of the network environment 100, but is associated with the HMD 101.

In one example embodiment, the AR application determines the AR content, in particular, a virtual character, to be rendered and displayed in the transparent lens of the HMD 101 based on sensor data related to the user 102, sensor data related to the HMD 101, and context data related to the AR application. Examples of sensor data related to the user 102 may include measurements of a heart rate, a blood pressure, brain activity, and biometric data related to the user 102. Examples of sensor data related to the HMD 101 may include a geographic location of the HMD 101, an orientation and position of the HMD 101, an ambient pressure, an ambient humidity level an ambient light level, and an ambient noise level detected by sensors in the HMD 101. Examples of context data may include a task performed by the user 102 or an identification of task instructions provided by the AR application. The sensor data related to the user 102 may also be referred to as user-based sensor data. The sensor data related to the HMD 101 may be also referred to as ambient-based sensor data.

For example, the HMD 101 may display a first virtual character (e.g., virtual receptionist) when the user 102 wearing the HMD 101 is on the first floor of a building (e.g., main entrance). The HMD 101 may display a second virtual character (e.g., a security guard), different from the first virtual character, when the user 102 is approaching a secured area of the building. In another example, the HMD 101 may display a different virtual character when the user 102 is alert and located in front of a machine in a factory. The HMD 101 may display a different virtual character or the same virtual character but with a different expression or animation when the user 102 is nervous or sleepy and is located in front of the same machine. In another example, the HMD 101 provides a first AR application (e.g., showing how to diagnose a machine) when the user 102 is identified as an electrician and is located in a first campus. The HMD 101 may provide a second AR application (e.g., showing how to fix a leak) when the user 102 is identified as a plumber and sensors in the bathroom indicate flooding. Therefore, different virtual characters and content, and different AR applications may be provided to the HMD 101 based on a combination of the user-based sensor data, the ambient-based sensor data, an identity of the user 102, and a task of the user 102.

In another example embodiment, the AR application may provide the user 102 with an AR experience triggered by identified objects in the physical environment 114. The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real world physical environment 114. The AR application may include computer vision recognition to determine corners, objects, lines, and letters. The user 102 may point a camera of the HMD 101 to capture an image of the physical object 116.

In one example embodiment, the physical object 116 in the image is tracked and recognized locally in the HMD 101 using a local context recognition dataset or any other previously stored dataset of the AR application of the HMD 101. The local context recognition dataset module may include a library of virtual objects (e.g., virtual character model and corresponding virtual character content) associated with real-world physical object 116 or references. In one example, the HMD 101 identifies feature points in an image of the physical object 116 to determine different planes (e.g., edges, corners, surface, dial and letters). The HMD 101 may also identify tracking data related to the physical object 116 (e.g., GPS location of the HMD 101, orientation, distance to physical object 116). If the captured image is not recognized locally at the HMD 101, the HMD 101 can download additional information (e.g., 3D model or virtual characters or other augmented data) corresponding to the captured image, from a database of the server 110 over the network 108.

In another example embodiment, the physical object 116 in the image is tracked and recognized remotely at the server 110 using a remote context recognition dataset or any other previously stored dataset of an AR application in the server 110. The remote context recognition dataset module may include a library of virtual objects (e.g., virtual character model) or augmented information associated with real-world the physical object 116, or references.

Sensors 112 may be associated with, coupled to, or related to the physical object 116 in the physical environment 114 to measure a location, information, or captured readings from the physical object 116. Examples of captured readings may include, but are not limited to, weight, pressure, temperature, velocity, direction, position, intrinsic and extrinsic properties, acceleration, and dimensions. For example, sensors 112 may be disposed throughout a factory floor to measure movement, pressure, orientation, and temperature. The server 110 can compute readings from data generated by the sensors 112. The virtual character may be based on data from sensors 112. For example, the virtual character may include a firefighter if the pressure from a gauge exceeds a safe range. In another example, the server 110 can generate virtual indicators such as vectors or colors based on data from sensors 112. Virtual indicators are then overlaid on top of a live image of the physical object 116 to show data related to the physical object 116. For example, the virtual indicators may include arrows with shapes and colors that change based on real-time data. The visualization may be provided to the HMD 101 so that the HMD 101 can render the virtual indicators in a display of the HMD 101. In another embodiment, the virtual indicators are rendered at the server 110 and streamed to the HMD 101. The HMD 101 displays the virtual indicators or visualization corresponding to a display of the physical environment 114 (e.g., data is visually perceived as displayed adjacent to the physical object 116).

The sensors 112 may include other sensors used to track the location, movement, and orientation of the HMD 101 externally without having to rely on the sensors 112 internal to the HMD 101. The sensors 112 may include optical sensors (e.g., depth-enabled 3D camera), wireless sensors (Bluetooth, Wi-Fi), GPS sensor, and audio sensors to determine the location of the user 102 having the HMD 101, a distance of the user 102 to the sensors 112 in the physical environment 114 (e.g., sensors 112 placed in corners of a venue or a room), the orientation of the HMD 101 to track what the user 102 is looking at (e.g., direction at which the HMD 101 is pointed, HMD 101 pointed towards a player on a tennis court, HMD 101 pointed at a person in a room).

The HMD 101 uses data from sensors 112 to determine the virtual character to be rendered or displayed in the transparent display of the HMD 101. The HMD 101 may identify or form a virtual character based on the sensor data. For example, the HMD 101 may select a security personal virtual character based on sensor data indicating an imminent danger or threat. In another example, the HMD 101 may generate a virtual character based on the sensor data. The virtual character may be customized based on the sensor data (e.g., the color of the skin of the virtual character may be based on the temperature of the environment ambient to the HMD 101).

In one embodiment, the image of the physical object 116 is tracked and recognized locally in the HMD 101 using a local context recognition dataset or any other previously stored dataset of the augmented reality application of the head mounted device 101. The local context recognition dataset module may include a library of virtual objects associated with real-world physical objects 116 or references. In one example, the HMD 101 identifies feature points in an image of a physical object 116 to determine different planes (e.g., edges, corners, surface of the machine). The HMD 101 also identifies tracking data related to the physical object 116 (e.g., GPS location of the head mounted device 101, direction of the head mounted device 101, e.g., HMD 101 standing a few meters away from a door or the entrance of a room). If the captured image is not recognized locally at the HMD 101, the HMD 101 downloads additional information (e.g., the three-dimensional model) corresponding to the captured image, from a database of the server 110 over the network 108.

In another embodiment, the image is tracked and recognized remotely at the server 110 using a remote context recognition dataset or any other previously stored dataset of an augmented reality application in the server 110. The remote context recognition dataset module may include a library of virtual objects associated with real-world physical objects 116 or references.

In one embodiment, the HMD 101 may use internal or external sensors 112 to track the location and orientation of the HMD 101 relative to the physical object 116. The sensors 112 may include optical sensors (e.g., depth-enabled 3D camera), wireless sensors (Bluetooth. Wi-Fi). GPS sensor, and audio sensor to determine the location of the user 102 having the head mounted device 101, distance of the user 102 to the tracking sensors 112 in the physical environment 114 (e.g., sensors 112 placed in corners of a venue or a room), the orientation of the HMD 101 to track what the user 102 is looking at (e.g., direction at which the HMD 101 is pointed, e.g., HMD 101 pointed towards a player on a tennis court, HMD 101 pointed at a person/object in a room).

In another embodiment, data from the sensors 112 in the HMD 101 may be used for analytics data processing at the server 110 for analysis on usage and how the user 102 is interacting with the physical environment 114. For example, the analytics data may track at what locations (e.g., points or features) on the physical or virtual object the user 102 has looked, how long the user 102 has looked at each location on the physical or virtual object, how the user 102 held the HMD 101 when looking at the physical or virtual object, which features of the virtual object the user 102 interacted with (e.g., such as whether a user 102 tapped on a link in the virtual object), and any suitable combination thereof. The HMD 101 receives a visualization content dataset related to the analytics data. The HMD 101 then generates a virtual object with additional or visualization features, or a new experience, based on the visualization content dataset.

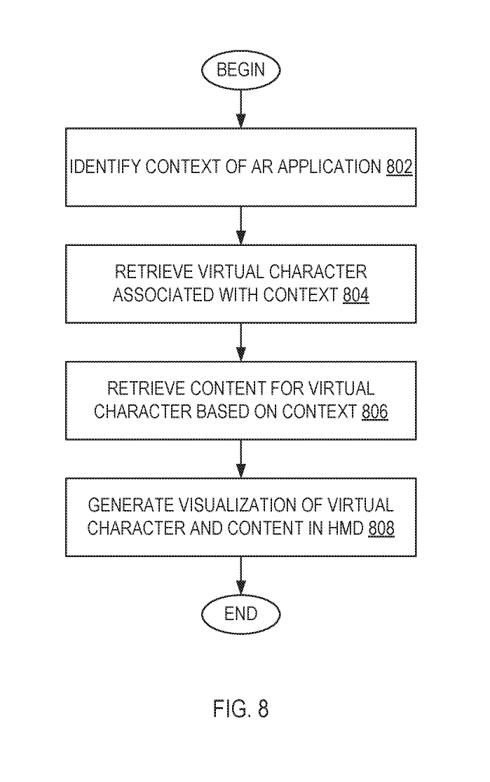

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 8, 9, and 10. As used herein, a “database” is a data storage resource and may store data structured as a text file, a table, a spreadsheet, a relational database (e.g., an object-relational database), a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., head mounted device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

FIG. 2 is a block diagram illustrating modules (e.g., components) of the HMD 101, according to some example embodiments. The HMD 101 may be a helmet that includes sensors 202, a display 204, a storage device 208, and a processor 212. The HMD 101 may not be limited to a helmet and may include any type of device that can be worn on the head of a user, e.g., user 102, such as a headband, a hat, or a visor.

The sensors 202 may be used to generate internal tracking data of the HMD 101 to determine a position and an orientation of the HMD 101. The position and the orientation of the HMD 101 may be used to identify real world objects in a field of view of the HMD 101. For example, a virtual object may be rendered and displayed in the display 204 when the sensors 202 indicate that the HMD 101 is oriented towards a real world object (e.g., when the user 102 looks at physical object 116) or in a particular direction (e.g., when the user 102 tilts his head to watch on his wrist). The HMD 101 may display a virtual object also based on a geographic location of the HMD 101. For example, a set of virtual objects may be accessible when the user 102 of the HMD 101 is located in a particular building. In another example, virtual objects including sensitive material may be accessible when the user 102 of the HMD 101 is located within a predefined area associated with the sensitive material and the user 102 is authenticated. Different levels of content of the virtual objects may be accessible based on a credential level of the user 102. For example, a user 102 who is an executive of a company may have access to more information or content in the virtual objects than a manager at the same company. The sensors 202 may be used to authenticate the user 102 prior to providing the user 102 with access to the sensitive material (e.g., information displayed as a virtual object such as a virtual dialog box in a see-through display 204). Authentication may be achieved via a variety of methods such as providing a password or an authentication token, or using sensors 202 to determine biometric data unique to the user 102.

FIG. 3 is a block diagram illustrating examples of sensors 202 in HMD 101. For example, the sensors 202 may include a camera 302, an audio sensor 304, an Inertial Motion Unit (IMU) sensor 306, a location sensor 308, a barometer 310, a humidity sensor 312, an ambient light sensor 314, and a biometric sensor 316. It is noted that the sensors 202 described herein are for illustration purposes. Sensors 202 are thus not limited to the ones described. The sensors 202 may be used to generate a first set of sensor data related to the user 102, a second set of sensor data related to the ambient environment of the HMD 101, and a third set of sensor data related to a context of an AR application. For example, the first set of sensor data may be generated by a first set of sensors 202. The second set of sensor data may be generated by a second set of sensors 202. The third set of sensor data may be generated by a third set of sensors 202. The first, second, and third set of sensors 202 may include one or more sensors 202 in common to all sets. In another example, a set of sensors 202 may generate the first, second, and third set of sensor data.

The camera 302 includes an optical sensor(s) that may encompass different spectrums. The camera 302 may include one or more external cameras aimed outside the HMD 101. For example, the external camera may include an infrared camera or a full-spectrum camera. The external camera may include a rear-facing camera and a front-facing camera disposed in the HMD 101. The front-facing camera may be used to capture a front field of view of the HMD 101 while the rear-facing camera may be used to capture a rear field of view of the HMD 101. The pictures captured with the front- and rear-facing cameras may be combined to recreate a 360-degree view of the physical world around the HMD 101.

The camera 302 may also include one or more internal cameras aimed at the user 102. The internal camera may include an infrared (IR) camera configured to capture an image of a retina of the user 102. The IR camera may be used to perform a retinal scan to map unique patterns of the retina of the user 102.

Blood vessels within the retina absorb light more readily than the surrounding tissue in the retina and therefore can be identified with IR lighting. The IR camera may cast a beam of IR light into the user 102's eye as the user 102 looks through the display 204 (e.g., lenses) towards virtual objects rendered in the display 204. The beam of IR light traces a path on the retina of the user 102. Because retinal blood vessels absorb more of the IR light than the rest of the eye, the amount of reflection varies during the retinal scan. The pattern of variations may be used as a biometric data unique to the user 102.

In another example embodiment, the internal camera may include an ocular camera configured to capture an image of an iris of the eye of the user 102. In response to the amount of light entering the eye, muscles attached to the iris expand or contract the aperture at the center of the iris, known as the pupil. The expansion and contraction of the pupil depends on the amount of ambient light. The ocular camera may use iris recognition as a method for biometric identification. The complex pattern on the iris of the eye of the user 102 is unique and can be used to identify the user 102. The ocular camera may cast infrared light to acquire images of detailed structures of the iris of the eye of the user 102. Biometric algorithms may be applied to the image of the detailed structures of the iris to identify the user 102.

In another example embodiment, the ocular camera includes an IR pupil dimension sensor that is pointed at an eye of the user 102 to measure the size of the pupil of the user 102. The IR pupil dimension sensor may sample the size of the pupil (e.g., using an IR camera) on a periodic basis or based on predefined triggered events (e.g., the user 102 walks into a different room, or there are sudden changes in the ambient light, or the like).

The audio sensor 304 may include a microphone. For example, the microphone may be used to record a voice command from the user 102 of the HMD 101. In other examples, the microphone may be used to measure ambient noise level to determine an intensity of background noise ambient to the HMD 101. In another example, the microphone may be used to capture ambient noise. Analytics may be applied to the captured ambient noise to identify specific types of noises such as explosions or gunshot noises.

The IMU sensor 306 may include a gyroscope and an inertial motion sensor to determine an orientation and movement of the HMD 101. For example, the IMU sensor 306 may measure the velocity, orientation, and gravitational forces on the HMD 101. The IMU sensor 306 may also detect a rate of acceleration using an accelerometer and changes in angular rotation using a gyroscope.

The location sensor 308 may determine a geolocation of the HMD 101 using a variety of techniques such as near field communication. GPS. Bluetooth, and Wi-Fi. For example, the location sensor 308 may generate geographic coordinates of the HMD 101.

The barometer 310 may measure atmospheric pressure differential to determine an altitude of the HMD 101. For example, the barometer 310 may be used to determine whether the HMD 101 is located on a first floor or a second floor of a building.

The humidity sensor 312 may determine a relative humidity level ambient to the HMD 101. For example, the humidity sensor 312 determines the humidity level of a room in which the HMD 101 is located.

The ambient light sensor 314 may determine an ambient light intensity around the HMD 101. For example, the ambient light sensor 314 measures the ambient light in a room in which the HMD 101 is located.

The biometric sensor 316 includes sensors 202 configured to measure biometric data unique to the user 102 of the HMD 101. In one example embodiment, the biometric sensors 316 include an ocular camera, an EEG (electroencephalogram) sensor, and an ECG (electrocardiogram) sensor. It is noted that the descriptions of biometric sensors 316 disclosed herein are for illustration purposes. The biometric sensor 316 is thus not limited to any of the ones described.

The EEG sensor includes, for example, electrodes that, when in contact with the skin of the head of the user 102, measure electrical activity of the brain of the user 102. The EEG sensor may also measure the electrical activity and wave patterns through different bands of frequency (e.g., Delta, Theta, Alpha, Beta, Gamma, Mu). EEG signals may be used to authenticate a user 102 based on fluctuation patterns unique to the user 102.

The ECG sensor includes, for example, electrodes that measure a heart rate of the user 102. In particular, the ECG may monitor and measure the cardiac rhythm of the user 102. A biometric algorithm is applied to the user 102 to identify and authenticate the user 102. In one example embodiment, the EEG sensor and ECG sensor may be combined into a same set of electrodes to measure both brain electrical activity and heart rate. The set of electrodes may be disposed around the helmet so that the set of electrodes comes into contact with the skin of the user 102 when the user 102 wears the HMD 101.

Referring back to FIG. 2, the display 204 may include a display surface or lens capable of displaying AR content (e.g., images, video) generated by the processor 212. The display 204 may be transparent so that the user 102 can see through the display 204 (e.g., such as in a head-up display).

The storage device 208 stores a library of AR content, reference ambient-based context, reference user-based context, and reference objects. The AR content may include two or three-dimensional models of virtual objects or virtual characters with corresponding animation and audio content. In other examples, the AR content may include an AR application that includes interactive features such as displaying additional data (e.g., location of sprinklers) in response to the user input (e.g., a user 102 says “show me the locations of the sprinklers” while looking at an AR overlay showing location of the exit doors). AR applications may have their own different functionalities and operations. Therefore, each AR application may operate distinctly from other AR applications. Each AR application may be associated with a user task or a specific application. For example, an AR application may be specifically used to guide a user 102 to assemble a machine.

The ambient-based context may identify ambient-based attributes associated with a corresponding AR content or application. For example, the ambient-based context may identify a predefined location, a humidity level range, and/or a temperature range for the corresponding AR content. Therefore, ambient-based context “AC1” is identified and triggered when the HMD 101 is located at the predefined location, when the HMD 101 detects a humidity level within the humidity level range, and when the HMD 101 detects a temperature within the temperature range.

The reference user-based context may identify user-based attributes associated with the corresponding AR content or application. For example, the user-based context may identify a state of mind of the user 102, physiological aspects of the user 102, reference biometric data, a user identification, and user privilege level. For example, user-based context “UC1” is identified and triggered when the HMD 101 detects that the user (e.g., user 102) is focused, not sweating, and is identified as a technician. The state of mind of the user 102 may be measured with EEG/ECG sensors connected to the user 102 to determine a level of attention of the user 102 (e.g., distracted or focused). The physiological aspects of the user 102 may include biometric data that was previously captured and associated with the user 102 during a configuration process. The reference biometric data may include a unique identifier based on the biometric data of the user 102. The user identification may include the name and tile of the user 102 (e.g., John Doe. VP of engineering). The user privilege level may identify which content the user 102 may have access to (e.g., access level 5 means that the user 102 may have access to content in virtual objects that are tagged with level 5). Other tags or metadata may be used to identify the user privilege level (e.g., “classified”, “top secret”, “public”).

The storage device 208 may also store a database of identifiers of wearable devices capable of communicating with the HMD 101. In another embodiment, the database may also identify reference objects (visual references or images of objects) and corresponding experiences (e.g., 3D virtual character models, 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most viewed devices and their corresponding experiences (e.g., virtual objects that represent the ten most sensing devices in a factory floor). In another example, the server 110 may generate the first set of images based on the most popular or often scanned images received at the server 110. Thus, the primary content dataset does not depend on physical object 116 or images scanned by the HMD 101.

The contextual content dataset includes, for example, a second set of images and corresponding experiences (e.g., three-dimensional virtual object models) retrieved from the server 110. For example, images captured with the HMD 101 that are not recognized (e.g., by the server 110) in the primary content dataset are submitted to the server 110 for recognition. If the captured image is recognized by the server 110, a corresponding experience may be downloaded at the HMD 101 and stored in the contextual content dataset. Thus, the contextual content dataset relies on the contexts in which the HMD 101 has been used. As such, the contextual content dataset depends on objects or images scanned by the AR application 214 of the HMD 101.

In one example embodiment, the HMD 101 may communicate over the network 108 with the server 110 to access a database of ambient-based context, user-based content context, reference objects, and corresponding AR content at the server 110. The HMD 101 then compares the ambient-based sensor data with attributes from the ambient-based context, and the ambient-based sensor data with attributes from the user-based context. The HMD 101 may also communicate with the server 110 to authenticate the user 102. In another example embodiment, the HMD 101 retrieves a portion of a database of visual references, corresponding 3D models of virtual characters, and corresponding interactive features of the 3D virtual characters.

The processor 212 may include an AR application 214 and a personification module 216. The AR application 214 generates a display of a virtual character related to the physical object 116. In one example embodiment, the AR application 214 generates a visualization of the virtual character related to the physical object 116 when the HMD 101 captures an image of the physical object 116 and recognizes the physical object 116 or when the HMD 101 is in proximity to the physical object 116. For example, the AR application 214 generates a display of a holographic virtual character visually perceived as a layer on the physical object 116.

The personification module 216 may determine ambient-based context related to the HMD 101, user-based context related to the user 102, and an application context (e.g., task of the user 102), and identify or customize a virtual character based on a combination of the ambient-based context, the user-based context, the identification of physical object 116, and the application context. For example, the personification module 216 provides a first virtual character for the AR application 214 to display in the display 204 based a first combination of ambient-based context, user-based context, application context, and object identification. The personification module 216 provides a second AR content to the AR application 214 to display the second virtual character in the display 204 based a second combination of ambient-based context, user-based context, application context, and object identification.

FIG. 4 is a block diagram illustrating an example embodiment of the personification module 216. The personification module 216 may generate AR content (e.g., a virtual character) based on a combination of the ambient-based context, the user-based context, the application-based context, and the identification of physical object 116. For example, the personification module 216 generates AR content “AR1” to the AR application 214 to display the AR content in the display 204 based on identifying a combination of ambient-based context AC 1, user-based context UC1, and an identification of the physical object 116. The personification module 216 generates AR content “AR2” to the AR application 214 based on a second combination of ambient-based context AC1, user-based context UC1, and an identification of the physical object 116.

The personification module 216 is shown, by way of example, to include a context identification module 402, a character selection module 404, and a character content module 406. The context identification module 402 determines a context which the user 102 is operating the HMD 101. For example, the context may include user-based context, ambient-based context, and application-based context. The user-based context is based on user-based sensor data related to the user 102. For example, the user-based context may be based on a comparison of user-based sensor data with user-based sensor data ranges defined in a library in the storage device 208 or in the server 110. For example, the user-based context may identify that the user 102's heart rate is exceedingly high based on a comparison of the user 102's heart rate with a reference heart rate range for the user 102. The ambient-based context may be based on a comparison of ambient-based sensor data with ambient-based sensor data ranges defined in a library in the storage device 208 or in the server 110. For example, the ambient-based context may identify that the machine in front of the HMD 101 is exceedingly hot based on a comparison of the machine's temperature with a reference temperature for the machine. The application-based context may be based on a comparison of application-based sensor data with application-based sensor data ranges defined in a library in the storage device 208 or in the server 110. For example, the application-based context may identify a task performed by the user 102 (e.g., the user 102 is performing a maintenance operation on a machine) based on the location of the HMD 101, the time and date of the operation, the user 102's identification, the status of the machine.

The character selection module 404 may identify or form a virtual character based on the context determined by the context identification module 402. The virtual character may include a three-dimensional model of, for example, a virtual person, an animal character, or a cartoon character. For example, the character selection module 404 determines the virtual character based on a combination of at least one of the user-based context, the ambient-based context, and the application-based context. For example, the character selection module 404 selects or forms a first virtual character based on the context identifying a combination of a first ambient-based context, a first user-based context, a first application-based context, and an identification of the physical object 116. The character selection module 404 selects or forms a second virtual character based on a second combination of a second ambient-based context, a second user-based context, a second application-based context, and an identification of the physical object 116. For example, a virtual character may be a first virtual character when the wearer of the HMD 101 is determined to be nervous. The virtual character may be a second virtual character when the physical object 116 is a specific machine that is malfunctioning. The virtual character may be a third virtual character when the HMD 101 is located in a particular building of a factory.

The character content module 406 may identify the content for the virtual character identified with the character selection module 404. For example, the character content module 406 may identify or form animation content and speech content. The animation content may identify how the virtual character is to be displayed and move around a physical landscape. For example, the virtual character may wear the same uniform as the wearer of the HMD 101. The wearer of the HMD 101 may perceive the virtual character as standing next to the physical object 116 and pointing to relevant parts (e.g., a malfunctioning part) of the physical object 116. The character content module 406 may also identify the speech content of what the virtual character is to say. For example, the speech content may include instructions on how to fix a machine.

In another example, the character content module 406 animates the virtual character based on the audio data received from another remote user. For example, in that case, the virtual character may be an avatar of the remote user and virtually represents the remote user.

Any one or more of the modules described herein may be implemented using hardware (e.g., a processor 212 of a machine) or a combination of hardware and software. For example, any module described herein may configure a processor 212 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 5 is a block diagram illustrating modules (e.g., components) of the server 110. The server 110 includes a processor 502, and a database 510. The server 110 may communicate with the HMD 101, and sensors 112 (FIG. 1) to receive real time data.

The processor 502 may include a server AR application 504. The server AR application 504 identifies real world physical object 116 based on a picture or image frame received from the HMD 101. In another example, the HMD 101 has already identified physical object 116 and provides the identification information to the server AR application 504. In another example embodiment, the server AR application 504 may determine the physical characteristics associated with the real world physical object 116. For example, if the real world physical object 116 is a gauge, the physical characteristics may include functions associated with the gauge, location of the gauge, reading of the gauge, other devices connected to the gauge, safety thresholds or parameters for the gauge. AR content may be generated based on the real world physical object 116 identified and a status of the real world physical object 116.

The server AR application 504 receives an identification of user-based context, ambient-based context, and application-based context from the HMD 101. In another example embodiment, the server AR application 504 receives user-based sensor data and ambient-based sensor data from the HMD 101. The server AR application 504 may compare the user-based context and ambient-based context received from the HMD 101 with user-based and ambient-based context in the database 510 to identify a corresponding AR content or virtual character. Similarly, the server AR application 504 may compare the user-based sensor data and ambient-based sensor data from the HMD 101 with the user-based sensor data library and ambient-based sensor data library in the database 510 to identify a corresponding AR content or virtual character.

If the server AR application 504 finds a match with user-based and ambient-based context in the database 510, the server AR application 504 retrieves the virtual character corresponding to the matched user-based and ambient-based context and provides the virtual character to the HMD 101. In another example, the server AR application 504 communicates the identified virtual character to the HMD 101.

The database 510 may store an object dataset 512 and a personification dataset 514. The object dataset 512 may include a primary content dataset and a contextual content dataset. The primary content dataset comprises a first set of images and corresponding virtual object models. The contextual content dataset may include a second set of images and corresponding virtual object models. The personification dataset 514 includes a library of virtual character models, user-based context, ambient-based context, application-based context, with an identification of the corresponding ranges for the user-based sensor data and ambient-based sensor data in the personification dataset 514.

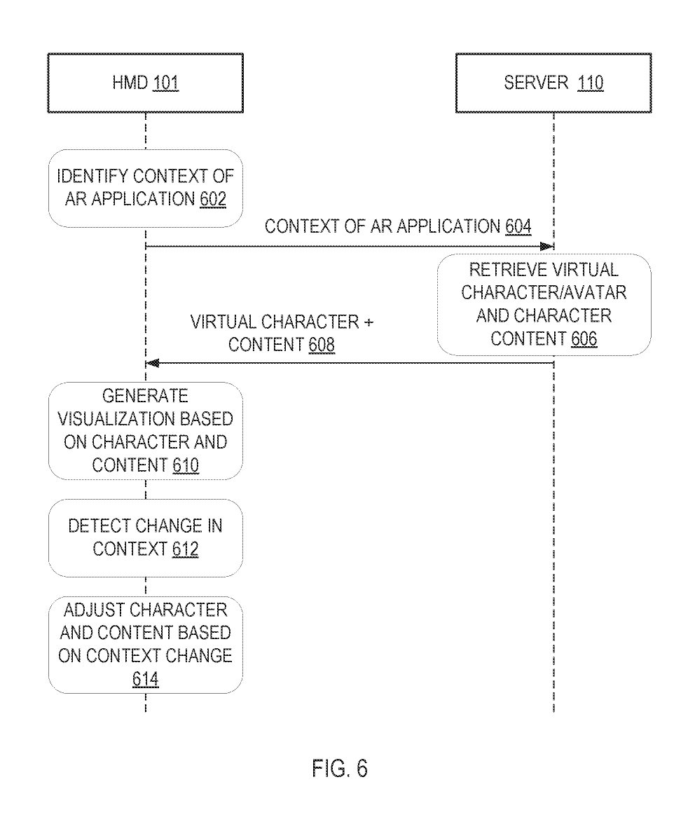

FIG. 6 is a ladder diagram illustrating an example embodiment of a system for virtual personification for an augmented reality system. At operation 602, the HMD 101 identifies a context within which the HMD 101 is used. For example, the HMD 101 identifies a user-based context, an ambient-based context, and an application-based context as determined using the context identification module 402 of FIG. 4. In another example, the HMD 101 identifies one or more real world objects 116, scenery, or a space geometry of the scenery, and a layout of the real world objects 116 captured by an optical device of the head mounted device 101.

At operation 604, the HMD 101 communicates the context to the server 110. In response, the server 110 identifies and retrieves a virtual character and corresponding character content based on the context, as shown at 606. At operation 608, the server 110 sends a 2D or 3D model of the virtual character back to the head mounted device 101. At operation 610, the HMD 101 generates a visualization of the virtual character (displays the virtual character) in a display 204 of the HMD 101. At operation 612, the HMD 101 detects a change in the context and accordingly adjusts the virtual character based on the change in the context at operation 614.

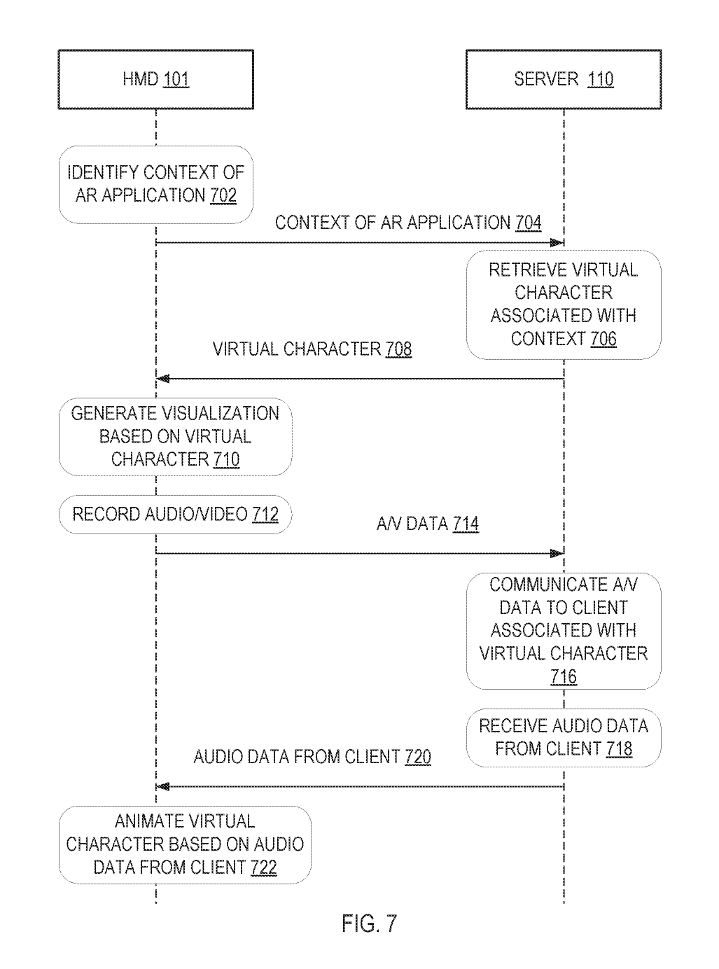

FIG. 7 is a ladder diagram illustrating an example embodiment for virtual personification for augmented reality system. At operation 702, the HMD 101 identifies a context within which the HMD 101 is used.

At operation 704, the HMD 101 communicates the context to the server 110. In response, the server 110 identifies and retrieves a virtual character and corresponding character content based on the context at operation 706. At operation 708, the server 110 sends a 2D or 3D model of the virtual character back to the head mounted device 101. At operation 710, the HMD 101 generates a visualization of the virtual character (displays the virtual character) in a display 204 of the HMD 101.

The HMD 101 may be used to interact with a remote user 102. For example, at operation 712, the HMD 101 may record the voice of the wearer of the HMD 101. In another example, the HMD 101 may record a video feed from a camera 302 of the HMD 101. The HMD 101 transmits the audio and video data to the server 110 at operation 714. The HMD 101 forwards the audio/video data to the corresponding remote user associated with the virtual character displayed at the HMD 101 at operation 716. The server 110 receives data from a client associated with the remote user at operation 718. The data may include audio data. At operation 720, the server 110 transmits the audio data to the head mounted device 101 which animates that virtual character based on the received audio data at operation 722.

FIG. 8 is a flowchart illustrating an example operation for virtual personification for an augmented reality system. At operation 802, the HMD 101 identifies a context of the HMD 101. At operation 804, the HMD 101 retrieves, identifies, or forms a virtual character associated with the context. At operation 806, the HMD 101 retrieves content for the virtual character based on the context. For example, the content identifies what the virtual character looks like, how the virtual character behaves, what the virtual character says. At operation 808, the HMD 101 generates a visualization of the virtual character and the corresponding character content (e.g., animation and audio content).

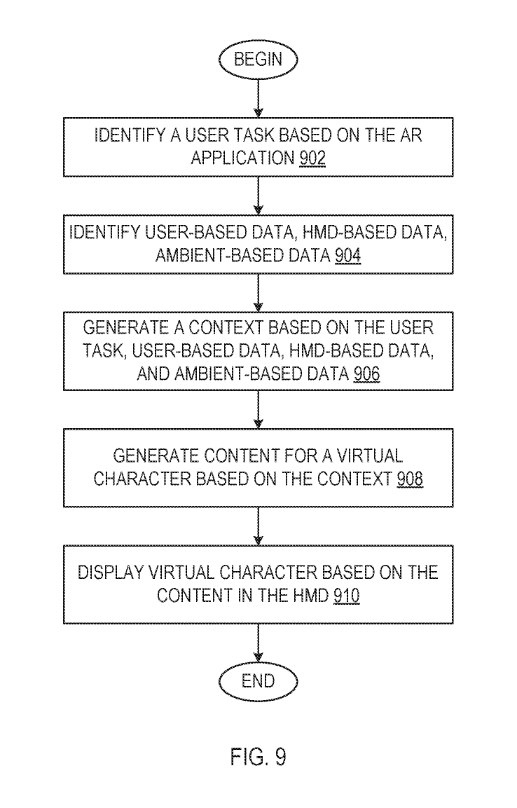

FIG. 9 is a flowchart illustrating another example operation of virtual personification for an augmented reality system. At operation 902, the HMD 101 identifies a user task based on the AR application. At operation 904, the HMD 101 identifies user-based data, HMD-based data, and ambient-based data based on sensors 202 in the HMD 101 (and sensors 202 external to the HMD 101). At operation 906, the HMD 101 generates a context based on the user-based data, HMD-based data, and ambient-based data. At operation 908, the HMD 101 generates content for a virtual character based on the context. Alternatively, the HMD 101 generates the virtual character and the corresponding content based on the context. At operation 910, the HMD 101 displays the virtual character in the HMD 101.

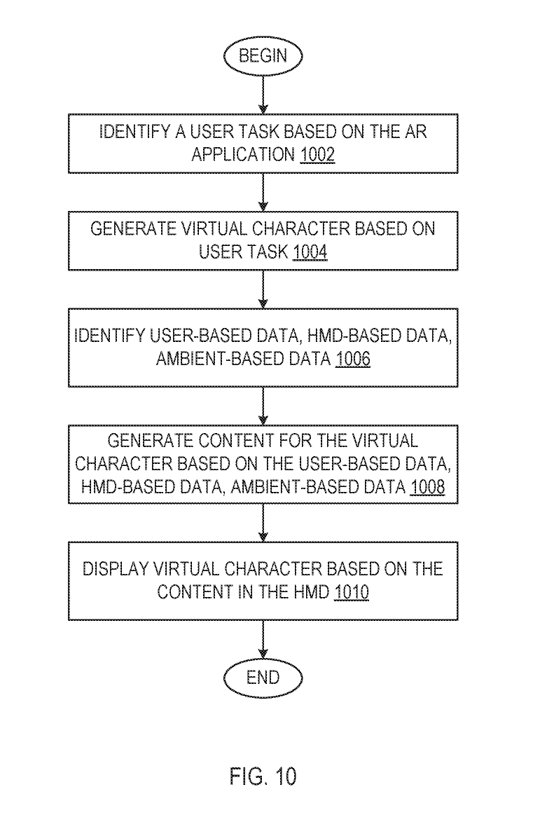

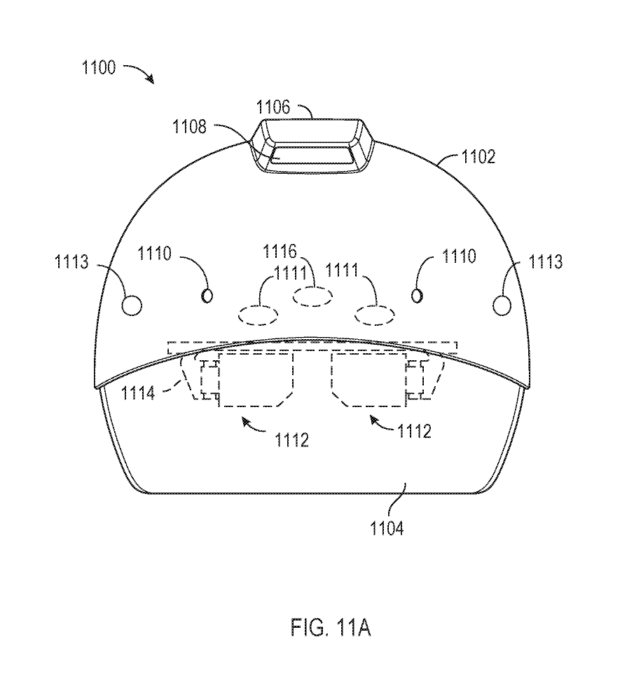

FIG. 10 is a flowchart illustrating another example operation of virtual personification for an augmented reality system. At operation 1002, the HMD 101 identifies a user task based on the AR application 214. At operation 1004, the HMD 101 generates a virtual character based on the user task. At operation 1006, the HMD 101 identifies user-based data, HMD-based data, and ambient-based data. At operation 1008, the HMD 101 generates content for a virtual character based on the context. Alternatively, the HMD 101 generates the virtual character and the corresponding content based on the context. At operation 1010, the HMD 101 displays the virtual character in the HMD 101.

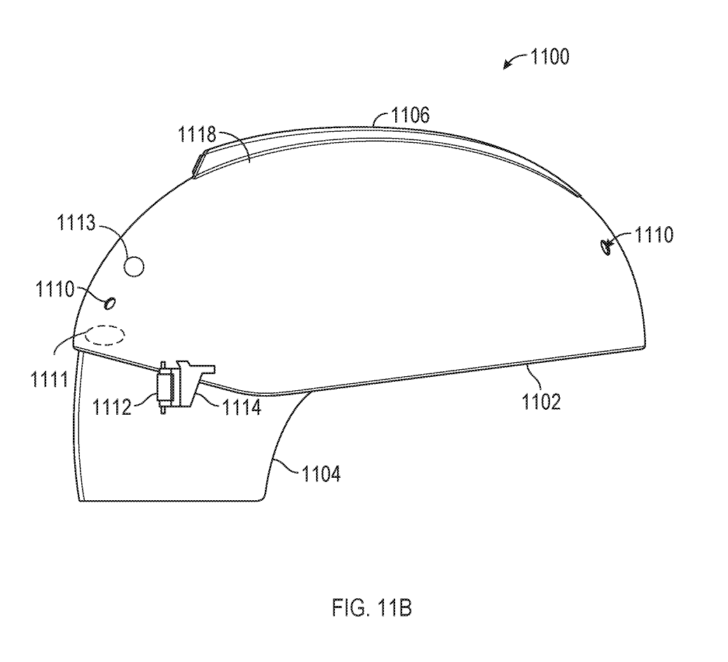

FIG. 11A is a block diagram illustrating a front view of a head mounted device 1100, according to some example embodiments. FIG. 11B is a block diagram illustrating a side view of the head mounted device 1100 of FIG. 11A. The HMD 1100 may be an example of HMD 101 of FIG. 1. The HMD 1100 includes a helmet 1102 with an attached visor 1104. The helmet 1102 may include sensors 202 (e.g., optical and audio sensors 1108 and 1110 provided at the front, back, and a top section 1106 of the helmet 1102). Display lenses 1112 are mounted on a lens frame 1114. The display lenses 1112 include the display 204 of FIG. 2. The helmet 1102 further includes ocular cameras 1111. Each ocular camera 1111 is directed to an eye of the user 102 to capture an image of the iris or retina. Each ocular camera 1111 may be positioned on the helmet 1102 above each eye and facing a corresponding eye. The helmet 1102 also includes EEG/ECG sensors 1116 to measure brain activity and heart rate pattern of the user 102.

In another example embodiment, the helmet 1102 also includes lighting elements in the form of LED lights 1113 on each side of the helmet 1102. An intensity or brightness of the LED lights 1113 is adjusted based on ambient conditions as determined by ambient light sensor 314 and the dimensions of the pupils of the user 102.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 502 or a group of processors 502) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 502 or other programmable processor 502) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 502 configured using software, the general-purpose processor 502 may be configured as respective different hardware modules at different times. Software may accordingly configure a processor 502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 502 that are temporarily configured (e.g., by software) or permanently configured to perform the relevant operations. Whether temporarily or permanently configured, such processors 502 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 502 or processor-implemented modules. The performance of certain of the operations may be distributed among the one or more processors 502, not only residing within a single machine, but deployed across a number of machines. In some example embodiments, the processor 502 or processors 502 may be located in a single location (e.g., within a home environment, an office environment or as a server farm), while in other embodiments the processors 502 may be distributed across a number of locations.

The one or more processors 502 may also operate to support performance of the relevant operations in a “cloud computing” environment or as a “software as a service” (SaaS). For example, at least some of the operations may be performed by a group of computers (as examples of machines including processors 502), these operations being accessible via a network 108 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 502, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 502 executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers 110. A client and server 110 are generally remote from each other and typically interact through a communication network 108. The relationship of client and server 110 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 502), or a combination of permanently and temporarily configured hardware may be a design choice. Below are set out hardware (e.g., machine) and software architectures that may be deployed, in various example embodiments.

### Example Machine Architecture and Machine-Readable Medium

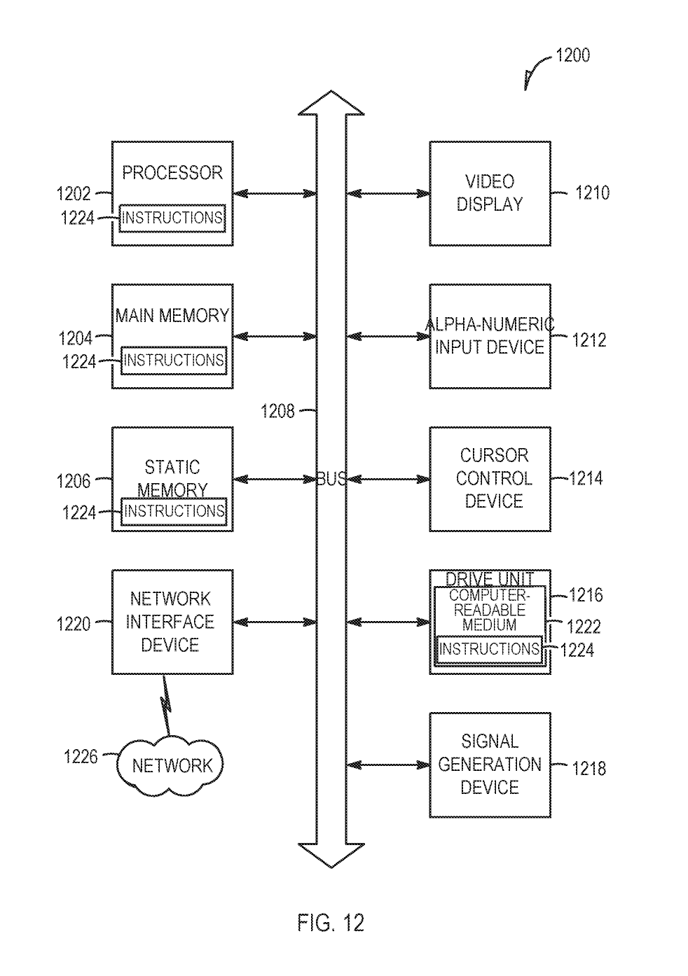

FIG. 12 is a block diagram of a machine in the example form of a computer system 1200 within which instructions 1224 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 110 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 1224 (sequential or otherwise) that specify actions to be taken by that machine. Further, while only a single machine is illustrated, the term “machine” shall also be taken to include any collection of machines that individually or jointly execute a set (or multiple sets) of instructions 1224 to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media 1222. The instructions 1224 may also reside, completely or at least partially, within the static memory 1206.

While the machine-readable medium 1222 is shown, in an example embodiment, to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions 1224 for execution by the machine and that cause the machine to perform any one or more of the methodologies of the present embodiments, or that is capable of storing, encoding or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 1224 for execution by the machine, and includes digital or analog communications signals or other intangible media to facilitate communication of such software.

### Example Mobile Device

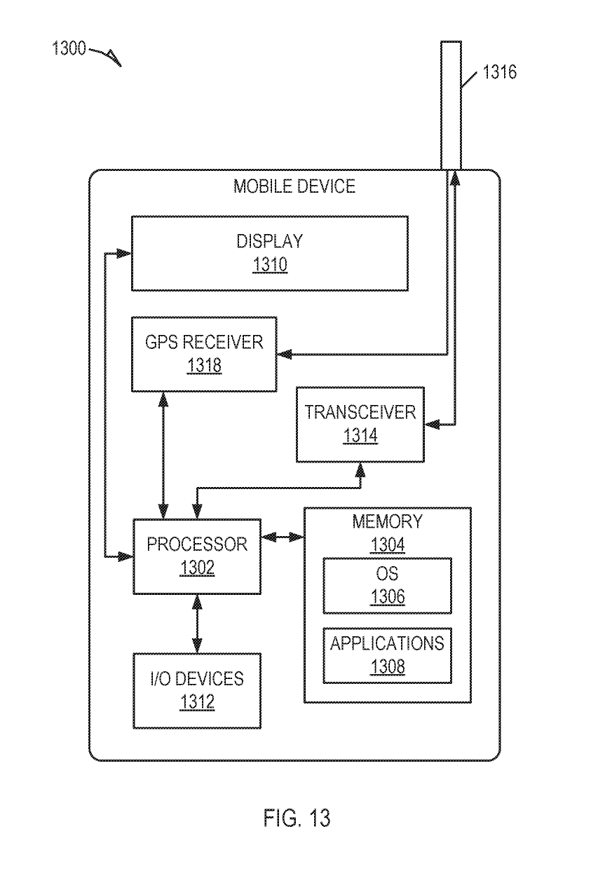

FIG. 13 is a block diagram illustrating a mobile device 1300, according to an example embodiment. The mobile device 1300 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or other type of memory, is typically accessible to the processor 1302. The memory 1304 may be adapted to store an operating system (OS) 1306, as well as application programs 1308, such as a mobile location enabled application that may provide location based services to a user 102. The processor 1302 may be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 may also make use of the antenna 1316 to receive GPS signals.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of methods, machine-readable media, and systems (e.g., machines, devices, or other apparatus) discussed herein.

A first embodiment provides a device (e.g., a head mounted device) comprising:

a transparent display;
a first set of sensors configured to measure first sensor data including an identification of a user of the HMD and a biometric state of the user of the HMD;
a second set of sensors configured to measure second sensor data including a location of the HMD and ambient metrics based on the location of the HMD; and
a processor configured to perform operations comprising:

determine a user-based context based on the first sensor data.

determine an ambient-based context based on the second sensor data.

determine an application context within an AR application implemented by the processor,

identify a virtual fictional character based on a combination of the user-based context, the ambient-based context, and the application context, and

display the virtual fictional character in the transparent display.

A second embodiment provides a device according to the first embodiment, wherein the processor is further configured to:

identify an object depicted in an image generated by a camera of the HMD, the object being located in a line of sight of the user through the transparent display;
access the virtual character based on an identification of the object;
adjust a size and a position of the virtual character in the transparent display based on a relative position between the object and the camera.

A third embodiment provides a device according to the first embodiment, wherein the first sensor data includes at least one of a heart rate, a blood pressure, or brain activity, wherein the second sensor data includes at least one of an orientation and position of the HMD, an ambient pressure, an ambient humidity level, or an ambient light level, and wherein the processor is further configured to identify a task performed by the user.

A fourth embodiment provides a device according to the first embodiment, wherein the processor is further configured to:

identify a character content for the virtual fictional character, the character content based on a combination of the user-based context, the ambient-based context, and the application context, the character content comprising an animation content and a speech content.

A fifth embodiment provides a device according to the fourth embodiment, wherein the processor is further configured to:

detect a change in at least one of the user-based context, the ambient-based context, and the application context; and
adjust the character content based on the change.

A sixth embodiment provides a device according to the first embodiment, wherein the processor is further configured to:

identify the virtual fictional character based on the application context;
record an input from the user of the HMD;
communicate the input to a remote server;
receive audio data in response to the input; and
animate the virtual fictional character based on the audio data.

A seventh embodiment provides a device according to the first embodiment, wherein the processor is further configured to:

identify the virtual fictional character based on a task performed by the user; and
generate a character content for the virtual fictional character, the character content based on a combination of the task, the user-based context, the ambient-based context, and the application context, the character content comprising an animation content and a speech content.

An eight embodiment provides a device according to the first embodiment, wherein the processor is further configured to:

compare the first sensor data with first reference sensor data for a task performed by the user;
determine the user-based context based on the comparison of the first sensor data with the first reference sensor data;
compare the second sensor data with second reference sensor data for the task performed by the user; and
determine the ambient-based context based on the comparison of the second sensor data with the second reference sensor data.

A ninth embodiment provides a device according to the eight embodiment, wherein the first reference sensor data includes a set of physiological data ranges for the user corresponding to the first set of sensors, a first set of the physiological data ranges corresponding to a first virtual character, and a second set of physiological data ranges corresponding to a second virtual character,

wherein the second reference sensor data includes a set of ambient data ranges for the HMD corresponding to the second set of sensors, a first set of ambient data ranges corresponding to the first virtual character, and a second set of ambient data ranges corresponding to the second virtual character.

A tenth embodiment provides a device according to the ninth embodiment, wherein the processor is further configured to:

change the virtual character based on whether the first sensor data transgress the set of physiological data ranges for the user, and whether the second sensor data transgress the set of ambient data ranges for the HMD.

What is claimed is:

1. A head mounted device (HMD) comprising:
a transparent display;
a first set of sensors configured to measure first sensor data including an identification of a user of the HMD and a biometric state of the user of the HMD;
a second set of sensors configured to measure second sensor data including a location of the HMD and ambient metrics based on the location of the HMD; and
a processor configured to perform operations comprising:
determine a user-based context based on the first sensor data,
determine an ambient-based context based on the second sensor data,
determine an application context within an AR application implemented by the processor,
identify a virtual fictional character based on a combination of the user-based context, the ambient-based context, and the application context, and
display the virtual fictional character in the transparent display.

2. The HMD of claim 1, wherein the processor is further configured to:
identify an object depicted in an image generated by a camera of the HMD, the object being located in a line of sight of the user through the transparent display;
access the virtual character based on an identification of the object; and
adjust a size and a position of the virtual character in the transparent display based on a relative position between the object and the camera.

3. The HMD of claim 1, wherein the first sensor data includes at least one of a heart rate, a blood pressure, or brain activity,
wherein the second sensor data includes at least one of an orientation and position of the HMD, an ambient pressure, an ambient humidity level, or an ambient light level, and
wherein the processor is further configured to identify a task performed by the user.

4. The HMD of claim 1, wherein the processor is further configured to:
identify a character content for the virtual fictional character, the character content based on a combination of the user-based context, the ambient-based context, and the application context, the character content comprising an animation content and a speech content.

5. The HMD of claim 4, wherein the processor is further configured to:
detect a change in at least one of the user-based context, the ambient-based context, and the application context; and
adjust the character content based on the change.

6. The HMD of claim 1, wherein the processor is further configured to:
identify the virtual fictional character based on the application context:
record an input from the user of the HMD;
communicate the input to a remote server;
receive audio data in response to the input; and
animate the virtual fictional character based on the audio data.

7. The HMD of claim 1, wherein the processor is further configured to:
identify the virtual fictional character based on a task performed by the user; and
generate a character content for the virtual fictional character, the character content based on a combination of the task, the user-based context, the ambient-based context, and the application context, the character content comprising an animation content and a speech content.

8. The HMD of claim 1, wherein the processor is further configured to:
compare the first sensor data with first reference sensor data for a task performed by the user;
determine the user-based context based on the comparison of the first sensor data with the first reference sensor data;
compare the second sensor data with second reference sensor data for the task performed by the user; and
determine the ambient-based context based on the comparison of the second sensor data with the second reference sensor data.

9. The HMD of claim 8, wherein the first reference sensor data includes a set of physiological data ranges for the user corresponding to the first set of sensors, a first set of the physiological data ranges corresponding to a first virtual character, and a second set of physiological data ranges corresponding to a second virtual character,
wherein the second reference sensor data includes a set of ambient data ranges for the HMD corresponding to the second set of sensors, a first set of ambient data ranges corresponding to the first virtual character, and a second set of ambient data ranges corresponding to the second virtual character.

10. The HMD of claim 9, wherein the processor is further configured to:
change the virtual character based on whether the first sensor data transgress the set of physiological data ranges for the user, and whether the second sensor data transgress the set of ambient data ranges for the HMD.

11. A method comprising:
measuring first sensor data including an identification of a user of a head mounted device (HMD) and a biometric state of the user of the HMD with a first set of sensors of the HMD;
measuring second sensor data including a location of the HMD and ambient metrics based on the location of the HMD with a second set of sensors;
determining a user-based context based on the first sensor data;
determining an ambient-based context based on the second sensor data;
determining, using a processor of the HMD, an application context within an AR application implemented by the processor of the HMD;
identifying a virtual fictional character based on a combination of the user-based context, the ambient-based context, and the application context; and
displaying the virtual fictional character in a transparent display of the HMD.

12. The method of claim 11, further comprising:
identifying an object depicted in an image generated by a camera of the HMD, the object being located in a line of sight of the user through the transparent display;
accessing the virtual fictional character based on an identification of the object; and
adjusting a size and a position of the virtual character in the transparent display based on a relative position between the object and the camera.

13. The method of claim 11, further comprising:
identifying a task performed by the user,
wherein the first sensor data includes at least one of a heart rate, a blood pressure, or brain activity, and
wherein the second sensor data includes at least one of an orientation and position of the HMD, an ambient pressure, an ambient humidity level, or an ambient light level.

14. The method of claim 11, further comprising:
identifying a character content for the virtual fictional character, the character content based on a combination of the user-based context, the ambient-based context, and the application context, the character content comprising an animation content and a speech content.

15. The method of claim 14, further comprising:
detecting a change in at least one of the user-based context, the ambient-based context, and the application context; and
adjusting the character content based on the change.

16. The method of claim 11, further comprising:
identifying the virtual character based on the application context;
recording an input from the user of the HMD;
communicating the input to a remote server;
receiving audio data in response to the input; and
animating the virtual character based on the audio data.

17. The method of claim 11, further comprising:
identifying the virtual fictional character based on a task performed by the user; and
generating a character content for the virtual fictional character, the character content based on a combination of the task, the user-based context, the ambient-based context, and the application context, the character content comprising an animation content and a speech content.

18. The method of claim 11, further comprising:
comparing the first sensor data with first reference sensor data for a task performed by the user;
determining the user-based context based on the comparison of the first sensor data with the first reference sensor data;
comparing the second sensor data with second reference sensor data for the task performed by the user; and
determining the ambient-based context based on the comparison of the second sensor data with the second reference sensor data.

19. The method of claim 18, wherein the first reference sensor data includes a set of physiological data ranges for the user corresponding to the first set of sensors, a first set of the physiological data ranges corresponding to a first virtual fictional character, and a second set of physiological data ranges corresponding to a second virtual fictional character,
wherein the second reference sensor data includes a set of ambient data ranges for the HMD corresponding to the second set of sensors, a first set of ambient data ranges corresponding to the first virtual fictional character, and a second set of ambient data ranges corresponding to the second virtual fictional character.

20. A non-transitory machine-readable medium comprising instructions that, when executed by one or more processors of a machine, cause the machine to perform operations comprising:
measuring first sensor data including an identification of a user of the machine and a biometric state of the user of the machine with a first set of sensors;
measuring second sensor data including a location of the machine and ambient metrics based on the location of the machine with a second set of sensors;
determining a user-based context based on the first sensor data;
determining an ambient-based context based on the second sensor data;
determining, using the one or more processors of the machine, an application context within an AR application implemented by the one or more processors of the machine;
identifying a virtual fictional character based on a combination of the user-based context, the ambient-based context, and the application context; and
displaying the virtual fictional character in a transparent display of the machine.
